(19) United States
(12) Patent Application Publication
(10) Pub. No.: US 2002/0178255 A1
(43) Pub. Date: Nov. 28, 2002

(54) Incentive program for a peer-to-peer network

(76) Inventor: John Hobart, Montreal (CA)

Correspondence Address: WILDMAN, HARROLD, ALLEN & DIXON, 225 WEST WACKER DRIVE, CHICAGO, IL, 60606, US

(21) Appl. No.: 09/961,650

(22) Filed: Sep. 24, 2001

Related U.S. Application Data
(60) Provisional application No. 60/291,023, filed on May 16, 2001.

(51) Int. Cl. G06F 15/16; G06F 15/173

(52) U.S. Cl. 709/224; 709/205

(57) ABSTRACT

The system and method are used to reward users in a peer-to-peer network for actively or passively contributing to resources of the network. The contributions of the peers are monitored at the local level and point values are determined in correlation with at least one monitored attribute. Peers are rewarded later based on the number of points earned. The system and method are designed to encourage peers to support the efficiency and the quality of a peer-to-peer network. Also disclosed is a method and a system for financing a peer-to-peer client software provider. In this system and method, peers pay a fee to be part of the incentive program and then become eligible for obtaining rewards.

The present application claims the benefits of U.S. provisional patent application No. 60/291,023 entitled “Incentive Program for a Peer-to-Peer Network” and filed May 16, 2001 to John HOBART, which application is hereby incorporated by reference.

The present invention relates to a system and a method by which users of a peer-to-peer network are incentivized and potentially rewarded for actively or passively contributing resources to the network. The present invention also relates to a system and a method for financing the activities of a peer-to-peer client software provider when users participate in such an incentive program.

Peer-to-peer networks, such as the Gnutella network, are dynamically formed and changed as peers connect to and disconnect from the network. Such networks are considered to be more useful and efficient when each user, or peer, allows other peers to use itself as an initial attachment point to the network, from which the newly connect peer can find other new direct connections. The initial attachments are called “incoming connections”. Once a peer has established a connection, that peer can submit requests for and download files from other peers on the network. If a peer only submits requests and downloads files, without contributing its own files and allowing requests to be routed through its connection, however, the network is less useful to other users and less efficient overall. Furthermore, if the number of peers allowing incoming connections is insufficient, the process of initially connecting to the network and of staying connected to the network can become unnecessarily lengthy and complicated. Conversely, the usefulness and efficiency of the network is enhanced when a large number of peers share their own files, permit searches to be routed through their connections, share other computer resources, such as storage and processing capacity, or otherwise positively contribute to the network.

At this stage, it should be noted that the term “peer” refers to a person or user of the network, as well as the computer used by that person to access the network, depending on the context. The term “node” is also a synonym of the term “peer,” but it is primarily used when referring to the computer connected to a network, rather than the person, the peer, using that computer.

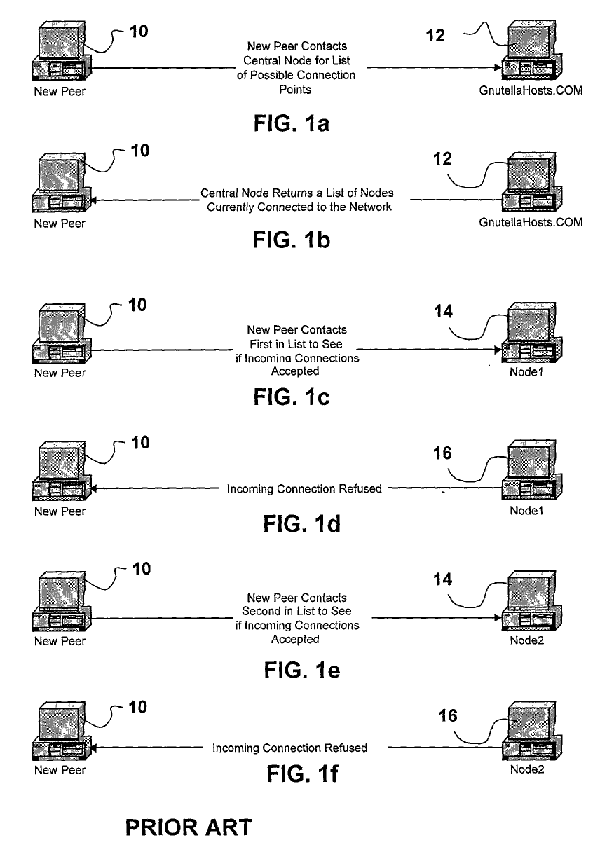

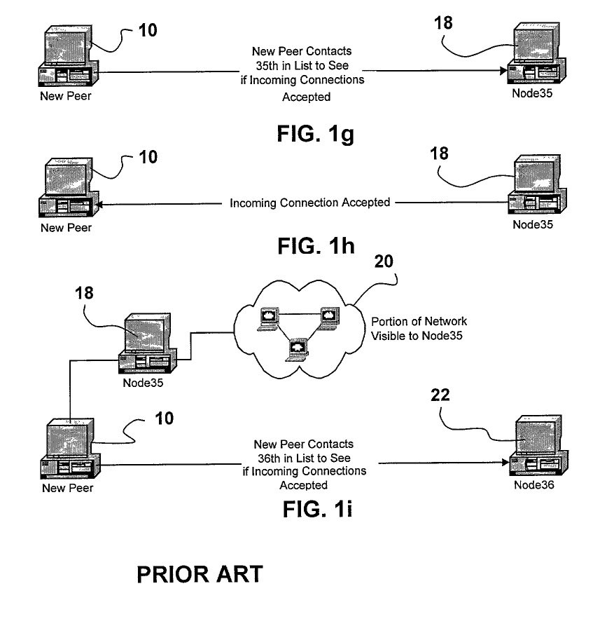

With reference now to prior art FIGS. 1a through 1i, an illustration is provided of the process that a new peer 10 might be required to follow in order to connect to the network. Before initiating the process, however, the potential new peer must obtain a copy of the software that will enable it to connect to the network. A user of the Gnutella network, a public peer-to-peer network, for example, might obtain a copy of the Gnotella file sharing software, which can be downloaded from www.gnotella.com, or other software that is compatible with the Gnutella network. Once the software has been installed and the corresponding software application started, the user would begin the connection process by contacting a central node 12 that maintains a large list of peers currently connected to the network. The existing peers are typically identified by their IP addresses, rather than by name or some other means of identification. The central node 12 could be, but is not necessarily, operated by the provider of the Gnutella-compatible software. The new peer 10 then works its way sequentially through the list of existing peers in an attempt to locate a possible connection point. To do so, the new peer 10 must contact at least some of the existing peers on the list, one by one, to see which of them will accept an incoming connection. Each new or existing peer ideally seeks to locate and maintain connections with a multitude of peers so that peer can be assured it will be able to stay connected to the network and realize the full potential of the network. Depending on the network conditions at the time, and the geographical or topographical location of the new peer 10 and existing peers, each attempt to connect to an existing peer can take a considerable amount of time. The new peer 10 may be refused tens, possibly hundreds of times before it contacts and connects to enough existing peers in the network that accept incoming connections to function at an acceptable level on the network.

As shown in FIG. 1b, the central node 12 returns a list of peers currently connected to the network. In FIG. 1c, the new peer 10 contacts the first peer in the list, in this case Nodel 14, to see if incoming connections are accepted by this peer. FIG. 1d illustrates an example where Nodel 14 informs the new peer 10 in a reply message that incoming connections are refused. The new peer 10 then contacts Node2 16 in the list to see if incoming connections are being accepted by this peer, as shown in FIG. 1e. Also, in this example, as shown in FIG. 1f, the incoming connection is again refused and a corresponding reply message is sent to the new peer 10.

This process continues until the new peer locates a node accepting incoming connections. In the above-described example, as shown in FIG. 1g, Node35 18 is the first existing peer that will accept the connection request from new peer 10 and complete the handshaking, interconnection, process. Accordingly, a connection message is sent to new peer 10 as shown in FIG. 1h. As previously noted, a new peer generally seeks to be connected to more than one node simultaneously, typically with three to ten different nodes. The connection process therefore typically takes place in a somewhat less linear fashion, i.e., a new peer typically does not wait for the first connection to be accepted or rejected before trying the other connections. In fact, a new peer will usually attempt to open simultaneously a large number of different connections, as determined by the user, and replace refused ones with new ones as the new peer goes through the list of existing peers.

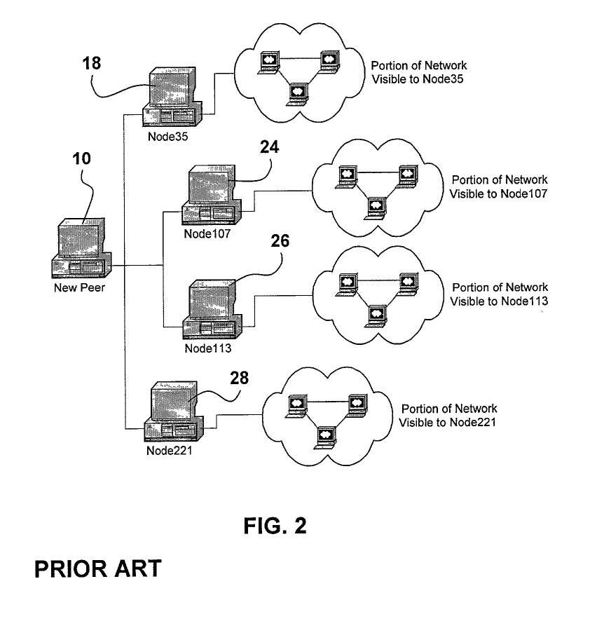

FIG. 1i illustrates the new peer 10 connected to Node35 18, and the network portion 20 visible to Node35 18, and attempting to contact Node36 22 from the list to see if Node36 22 is accepting incoming connections. With reference to FIG. 1i, it is particularly important to note that the new peer 10 only has access to the portion of the network that is interconnected to Node35 18, and that this network portion 20 only constitutes a potentially small portion of the overall network. In order for a peer to have access to a larger portion of the network, and therefore a larger number of files and network user resources, a peer needs to be connected to multiple other peers that are in turn connected to multiple other peers. Accordingly, whenever an existing peer chooses not to allow incoming connections, each new peer's experience associated with connecting to the network is adversely affected, as is the random nature of the network's topology. As a result, many new peers will not be able to join the network and the resultant network of existing peers will be highly fragmented. In other words, entire groups of peers may be isolated from other groups of peers within the network and searches initiated by peers in one group will not be sent to peers in the other group. As is illustrated in prior art FIG. 2, new peer 10 has access to a substantially larger portion of the network as a result of the four outgoing connections or “peering points” it has established with Node35 18, Node107 24, Node113 26 and Node221 28.

With each new peering point to which the new peer 10 connects, it “sees” or gains access to a larger portion of the network, and a larger portion of the network gains access to it. What portion of the overall network the new peer 10 can ultimately see is random, but generally, the visible portion of the network will be increased by the number of nodes to which a peer is able to connect.

If a new connection results in a previously nonexistent link between two fragments of the whole network, the new peer 10 will act as a relay between the two, helping to defragment the network as a whole. Should one of the new peer's connection points drop from the network, it will lose contact with that fragment of the network unless the two fragments are peered through another connection.

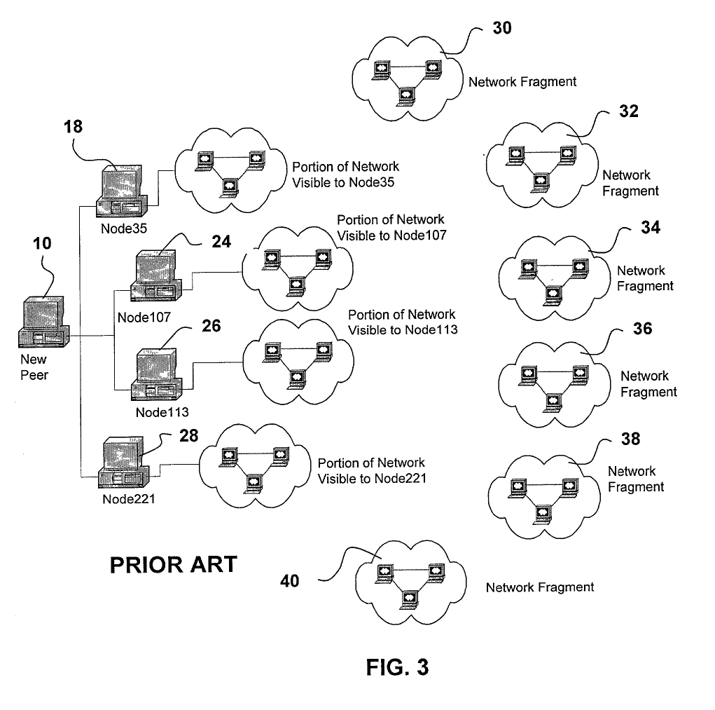

Prior art FIG. 3 illustrates a typical example of a fragmented network. In this case, entire groups of peers 30 through 40 are isolated from the other groups connected through Node35 18, Node107 24, Node113 26 and Node221 28. If a peer in the group connected to Node35 18 is searching for a particular file, the search request for that file will never reach peers within groups 30 to 40 if the network is fragmented. In a network thus fragmented, two peers may be caused to effectively reside on separate networks within the same global network. This negatively affects the performance and efficiency of the peer-to-peer network. This scenario is more likely to occur when the number of peers is low.

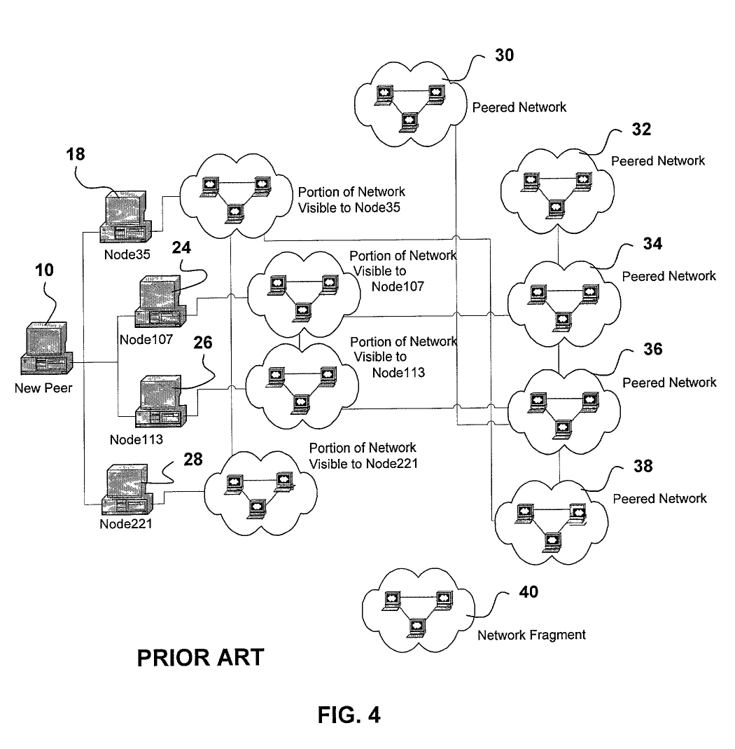

Defragmentation of the network occurs, statistically, as the number of peers increases because the addition of new peers forms and maintains connections between the network fragments, especially when many peers allow incoming connections. As illustrated in prior art FIG. 4, the fragmented network illustrated in FIG. 3 is shown as being less fragmented because peers within the portion of the network visible to a node connected to the new peer 10 have accepted incoming connections from peers within other portions of the network. The differences between FIG. 3 and FIG. 4 illustrate the importance of providing peers with incentives to remain connected and to offer incoming connections to other peers. In such instances the network itself will become more robust, allowing the presence of more searchable files, more reliable connections and fewer dropped packets.

The present invention is therefore aimed at incentivizing peers inter alia to allow incoming connections, share data, files, computing resources, remain connected to the network, etc. More particularly, it relates to providing an incentive program whereby peers actively and/or passively participating in the network are rewarded in correlation with one or more predetermined parameters. It also relates to providing an incentive program for financing the activities of a peer-to-peer client software provider.

These and other aspects and advantages of the present invention will be better understood from the following description and accompanying figures in which:

FIGS. 1a to 1i illustrate various typical prior art steps for connecting a new peer in a peer-to-peer network;

FIG. 2 illustrates a prior art example of the visible portion of a network to the new peer once the initial connection process is completed;

FIG. 3 illustrates a prior art example of a fragmented peer-to-peer network;

FIG. 4 is an illustration that is similar to FIG. 3, but conversely illustrating an example of network defragmentation caused by an increased number of peers accepting incoming connections;

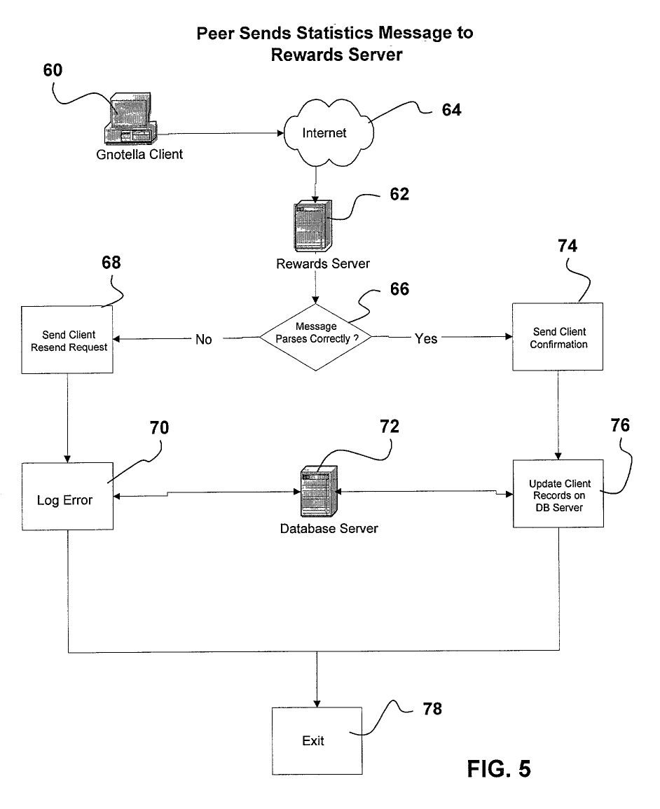

FIG. 5 is a flow-chart diagram depicting a rewards server receiving statistics updated from the peer in accordance with a possible embodiment of the present invention; and

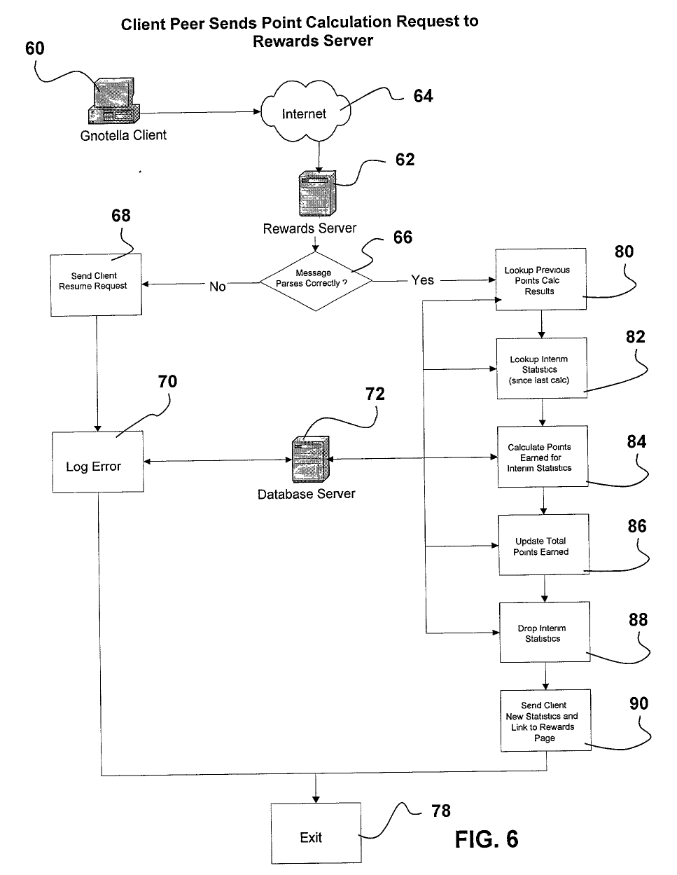

FIG. 6 is a flow-chart illustrating the processing of a request from a peer to calculate reward points or other such credits.

In accordance with the present invention, the file sharing software used by a new peer is modified to include code that enables a new peer to communicate with an incentive system upon interconnection to a peer-to-peer network. Due to a peer's interaction with the incentive system, the peer will be incentivized to take certain actions that will thereafter make the connection process less arduous for the peer as well as other peers and result in a less fragmented network topology.

Once the new peer has connected to the network for the first time, and appropriately registered for the incentive program, statistics will begin to accumulate pertaining to its positive contributions to the network. A positive contribution would include any of a variety of actions, or inactions, by a peer, including actively or passively permitting incoming connections, contributing files, allowing the peer's processor or storage to be used by other peers on the network, etc. A peer could passively permit incoming connections if its file sharing software was configured to permit incoming connections and the peer did nothing to change this configuration setting.

Preferably, firewalled peers that specifically map ports through their firewall to allow incoming connections both from other peers and from the rewards server are eligible to receive rewards.

Upon connection, a new peer will be prompted to register its file sharing software with the incentive program and, if it paid a fee it would qualify for rewards that were earned by the peer based on the number of points or other such credits it accumulated. The enrollment fee could be a one time fee, or preferably paid on a subscription basis with each fee covering only a limited period of time that could be renewed upon payment of a renewal fee. In addition to being eligible for rewards, registered peers could receive other benefits such as rebates, a newsletter or magazine, exclusive access to certain promotions, etc.

When a peer registers its software to initiate a rewards session, a unique code identifying that particular peer is associated with information the peer entered at the time of registration. This may include one or more of the following:

Name (First, Last, Initial)

Address for Accounting Purposes

Address for Shipping Purposes

Email Address

Preferred Password

Other information may be collected as well, but not all of the information listed will necessarily be compulsory for the peer to enter the rewards program or be required for the correct functioning of the rewards program. A preferred password might not be collected at the time of registration; it might be assigned to the user by the server or automatically generated based on a unique client software identifier. A password might be unnecessary if there are sufficient other means to identify users and to prevent other users from claiming their reward points. The requirement for a password could also interfere with some users' ability to connect to the network or otherwise operate the software.

Preferably, the peer's client software is provided with means for recording statistics pertaining to the level of its own participation in the network during a rewards session. These statistics may include one or more of the following attributes:

total bytes incoming (messaging bytes in, transfers in);

total bytes outgoing (messaging bytes out, transfers out);

total files successfully uploaded from host (bytes and number of files);

distributed processing (shared operations, such as CPU cycles spent);

distributed storage (available files, free (i.e. committed and utilized) disk space used by the network for caching operations); and

uptime connected to the network, or node availability.

Other parameters may be used as well. The local file containing the aggregate statistics could be encrypted both while stored locally and when transmitted, as a message, with or without attachments, to the rewards server to prevent fraudulent use of the incentive program.

Another possible embodiment is to have the peers' client software provided with means for monitoring one or more attributes and converting it or them (either before or after locally storing them) into reward points. Therefore, the local file may contain only points, and would be encrypted as such while stored locally. Alternatively, the point file could be encrypted prior to being transmitted to the server.

The processing of statistics to compute the number of points earned by a peer is done in accordance with rules. The rules contain a conversion value for one or more of the monitored attributes. If the attribute or attributes are converted into points at the peer level, the rules can be permanently embedded into the peers' client software and updated when a new version of the software is installed. Rules can also be stored in a local file or a networked file that can be updated from time to time through a packet-based protocol, such as TCP/IP. For example, when the client software contacts the rewards server to initiate a rewards session, the rewards server could download a new set of rules, or portions of the rule, to the node running the client software.

Also, when the peers' client software is used for converting statistics into points, the conversion can be done on a continuous basis, with only a limited amount of statistics being recorded at a time and being subsequently erased as the conversion progresses. Alternatively, the conversion can be done by continuously processing statistics without recording them, points being then accumulated as fractions. Another possibility is to record statistics in a local file or in memory, and then convert them on an intermittent basis.

In the preferred embodiment, the rules are maintained at the server level since this allows a greater control and more flexibility to change them whenever such is required. It is further possible to provide rules that are changed dynamically, or rules that are applied contextually. For example, some rules could be applied differently during a given part of the day or whenever a particular need is to be fulfilled, such as if the number of peers accepting incoming connections is very low during a given part of the day or at given days of the year, more points could be earned by peers fulfilling those needs.

A further possible embodiment is to allow peers to select the attribute or attributes that will be monitored and converted into points or other such credits. This option would give a greater flexibility to peers and satisfy the needs of some peers having concerns with regard of confidentiality issues. For instance, a peer may prefer that the number of shared files be not monitored, and consequently, chose to be eligible for rewards based only on other possible recorded attributes, such as the number of incoming and outgoing bytes.

Moreover, in the preferred embodiment, the aggregate statistics of each peer, or the points associated with a rewards session for a peer, are uploaded to the rewards server upon request from a peer, such as at the conclusion of a rewards session, or any other time the peer may desire or the client software provider establishes. The rewards server then processes the information to determine the number of points attained since the last upload, the total number of points obtained, and the total number of points available for spending or the like.

FIG. 5 illustrates an example of what happens when a peer sends a statistics message to the rewards server. The Peer, identified as Gnotella client 60 connects to rewards server 62 through the Internet 64. Upon receipt of the information file from Gnotella client 60, the rewards server 62 first determines whether the message containing the information file can be correctly parsed, i.e., the message and accompanying file are in the correct format or were not damaged during transmission, as illustrated in block 66. If the message cannot be parsed, a resend request is sent to client 60, block 68, through the server 62, and an error is logged, block 70, in the database server 72. In the preferred embodiment, database server 72 acts as an additional storage and processing resource for server 62, but an additional database server is not required to practice the current invention, since all of the requisite functions could be performed by the rewards server 62 in the absence of the database server 72. If the message could be parsed, a confirmation message is sent to the client 60, block 74, and the information file is processed by the rewards server 62 and the client 60 records are then updated, block 76, within the database server 72, or the rewards server 62 as the case may be. Once the processing and storing steps have been completed, the statistical processing function exits, block 78.

The points calculation request and the resultant reply may be a separate process. In any case it will require a similar algorithm. FIG. 6 illustrates an example of what happens when a peer sends a point calculation request to the rewards server. With respect to FIG. 6, common elements are denoted with common identifiers. If the point calculation request parses correctly, the rewards server 62 looks up the previous points calculation results, block 80, and the interim statistical information since the last request or point calculation, block 82. Based on this information, the points earned so far are calculated, block 84, and the database 72 is updated, block 86. The update can be stored in a new location, or used to replace the prior interim statistics, or the prior interim statistics could be deleted, block 88. The new statistics would then be sent to the client 60, typically along with a link to the rewards page on a web site maintained by the provider of the rewards program, block 90. Preferably, upon arriving at the rewards page, the peers will be automatically logged in and able to access their statistics page detailing their past network contributions. It is also possible that the peers' client software be used, with appropriate means, to provide statistics and/or an indication of the accumulated reward points or other such credits.

In the preferred embodiment, the peer will periodically upload statistics to a server on which the rewards management software is located. This upload may be automatically initiated or may be initiated upon a request from the user It may be also uploaded following a request from the server itself. This upload of statistics is preferably made in the form of an encrypted message sent to the server and containing the information required to manage the program, such as peer or user ID or identifier, and the aggregate statistics collected since the last upload, some or all of which might be used in the actual calculation of points earned. A record for a particular peer would have been created and updated either previously or at the first upload. The peer may communicate with the server either through a web site, the client software or even through a conventional means, such as monthly statements received by mail, automated-telephone access system, etc.

Rewards points can be exchanged by a user for merchandise discounts or “give-aways”, benefits, tickets for lotteries, or could be directly credited to a credit card account maintained by a user, etc. The more points earned, the more valuable the rewards will be or the more can be obtained. The exchange of points can be made automatically or following a peer's request. It could be also a combination of both. For instance, rewards could be sent or allocated automatically whenever a given threshold is reached. They could also be sent or allocated automatically, as previously determined by the peer. Preferably, rewards points would be exchanged following a request from a peer logging onto the network's rewards web site and selecting an item that s/he wants in exchange for the rewards points accumulated.

Rewards points earned by a peer could also be converted into a credit for obtaining copyrighted material or other proprietary items or content, either from the rewards server, or another web site. They could also be used to provide peers privileged or prerelease access to events or a new item, for example a new song, a new movie, etc.

In all of the above-mentioned cases, points can be redeemed through a third party, such as a fulfillment house or a merchant, with whom the peers exchange their points for something in return. This can be done to expand or vary what is available to the peers. Alternatively, the reward program can be completely imparted to a third party or parties. Another possible scenario is to have the server simply send award redeeming orders to a third party, which in this case will prepare and send the awards to peers. The rewards server can then be provided with a dynamic link to such third party, or any other means, to ensure inform peers of rewards that are available at the time they want to redeem their points. Many other scenarios are also possible.

### EXAMPLES

The following are examples of how the reward program works. It should be noted that these examples are for purposes of illustration only.

As aforesaid, rewards can be exchanged for various merchandise discounts or “give-aways”, benefits, promotions, etc. For the purpose of the examples, the following values could be assigned to the listed rewards items:

| | | |
|---|---|---|
| Ballpoint Pen | 500 | points |
| Key Chain | 750 | points |
| T-shirt | 2500 | points |
| Baseball Cap | 2900 | points |
| Long Sleeve Shirt | 3600 | points |
| Pocket Knife | 4500 | points |
| Toaster Oven | 7000 | points |
| Pocket PC | 1,200,000 | points |

USER1 downloads the “Gnotella” client software and once installed, is sent to a web page describing the rewards program. USER1 elects to subscribe to the registered version of the software, pays for it, and his client software immediately begins recording statistics pertaining to his use of and contributions to the network. Since USER1 allows incoming connections, in this case through a cable internet connection, and leaves his computer connected to the network full time, even though he has no files explicitly shared, during the next following months, USER1 continuously accumulates points due to the search traffic propagating through his node. Once a significant amount of points has been accumulated, USER1 requests a rewards points calculation from the server and is told that 5382 points were accumulated for spending. USER1 then logs onto the rewards web page and finds that a number of items costing fewer points than the number accumulated. In this example, USER1 obtains a pocket knife. USER2 downloads the “Gnotella” client software and once installed, is sent to a web page describing the rewards program. USER2 elects to subscribe to the registered version of the software, pays for it, and her client software immediately begins recording statistics pertaining to her use of and contributions to the network. USER2 has installed the registered version of the client software over a firewalled connection but has specifically mapped ports to allow incoming connections. USER2 is a home video fanatic, and over the years has accumulated sufficient footage of a humorous nature that her node incurs significant traffic. Over a period of one year USER2 saves points and accumulates 1,300,000 points, enough to purchase the Pocket PC and a few T-shirts to give away to relatives.

As can be appreciated, although the above-described incentive method or system will not prevent peers from “free riding” the network, it is believed that it will encourage enough peers to support the efficiency and quality of the network. The participating peers will also now be rewarded for their contribution.

The above-described method and system is also a very suitable way of financing the activities of a peer-to-peer software provider, in particular in the Gnutella network. Receiving fees from participating users will generate revenues to fund the incentive program, in particular the purchase and operational costs associated with the reward server and that of the rewards themselves. If properly managed, expenses will be exceeded by the revenues necessary to generate a profit, which profit will in turn allow the peer-to-peer software provider to fund the development and distribution of the software, all with a suitable profit margin.

Moreover, the above-mentioned method and system will allow the software provider to generate revenues without using background or “stealth” advertising components, known as “spyware” or “adware.” These components install themselves into users' computers and then start collecting personal information about those users. The collected information is later transmitted to the software provider or a third party, sometimes even without users' knowledge or consent. This kind of financing is usually not acceptable for the vast majority of users and can deter them from using or installing the software once they learn about it.

It should be noted that the registration fees from the peers can be replaced by a contribution from a sponsor as part of one of its promotion campaign. In this scenario, the peers would still register with the incentive program but at no cost or for an insignificant amount. The peer-to-peer client software provider could receive an amount from the sponsor for each participant in the program. It can also receive a global amount from the sponsor. A combination of the two or even other methods are also possible. Points would then be redeem for something supplied by the sponsor. An example of a possible sponsor for this embodiment is a soft drink company.

Although possible embodiments of the invention have been described in detail herein and/or illustrated in the accompanying figures, it is to be understood that the invention is not limited to these precise embodiments and that various changes and modifications may be effected therein without departing from the scope of spirit of the present invention. It is also intended that the disclosed examples be considered as exemplary only and not limiting the present invention in any way.

What is claimed is:

1. A method for assigning points to a peer in a peer-to-peer network, based on contributions of the peer to the network, the method comprising:
monitoring at least one attribute indicative of the contribution of the peer to the network;
determining a point value in correlation with the monitored attribute; and
making the point value available to the peer for review.

2. A method in accordance with claim 1, wherein the point value is redeemed by the peer for a reward.

3. A method in accordance with claim 1, wherein the attribute is selected among the number of bytes incoming to the peer, the number of bytes outgoing from the peer, the number of files successfully uploaded from the peer, the distributed processing made available by the peer, the distributed storage space made available by the peer, and the uptime during which the peer is connected to the network.

4. A method in accordance with claim 1, wherein the act of monitoring comprises recording data at a peer level and transmitting the recorded data to a rewards server.

5. A method in accordance with claim 4, wherein the act of determining a point value is carried out at the rewards server.

6. A method in accordance with claim 5, further comprising encrypting the recorded data before transmitting them to the rewards server.

7. A method in accordance with claim 6, wherein the recorded data are transmitted to the rewards server following a request from the peer.

8. A method in accordance with claim 6, wherein the recorded data are transmitted to the rewards server following a request received from the rewards server.

9. A method in accordance with claim 6, wherein the recorded data are transmitted to the rewards server as a scheduled event.

10. A method in accordance with claim 1, wherein the act of monitoring comprises recording data at a peer level and wherein the act of determining a point value is also carried out at the peer level, the method further comprising transmitting the point value to a rewards server.

11. A method in accordance with claim 10, further comprising encrypting the point value before transmitting it to the rewards server.

12. A method in accordance with claim 10, wherein the point value is determined using supplied rules for converting a value associated with the attribute being monitored.

13. A method in accordance with claim 12, wherein the attribute is selected among the number of bytes incoming to the peer, the number of bytes outgoing from the peer, the number of files successfully uploaded from the peer, the distributed processing made available by the peer, the distributed storage space made available by the peer, and the uptime during which the peer is connected to the network.

14. A method in accordance with claim 13, wherein the attribute is selected by the peer.

15. A method in accordance with claim 12, wherein the rules are fixed within a given version of a software through which the peer communicates with the peer-to-peer network.

16. A method in accordance with claim 12, wherein the rules are changeable and are supplied by the rewards server using a packed-based protocol.

17. A method for dispensing rewards to a peer in a peer-to-peer network, based on contribution of the peer to the network, such method comprising:
collecting statistics concerning at least one attribute indicative of the contribution of the peer to the network;
transmitting the collected statistics to a rewards server;
processing the collected statistics to determine a new point value; and
adding the new point value to obtain a new total number of points for that peer.

18. A method in accordance with claim 17, further comprising:
selecting at least one reward based on the total points accumulated by the peer, the reward having a reward point value;
subtracting the reward point value from the total point value of the peer; and
sending the reward to the peer.

19. A method in accordance with claim 17, further comprising:
allowing the peer to select at least one reward from a list of available rewards, each reward having a reward point value; and
upon determining that the peer is eligible for receiving the selected reward based on the total point value thereof:
subtracting the reward point value from the total point value; and
sending the selected reward to the peer.

20. A method in accordance with claim 17, further comprising:
allowing the peer to select at least one reward from a list of rewards available through a third party, each reward having a reward point value; and
upon determining that the peer is eligible for receiving the selected reward based on the total point value thereof:
subtracting the reward point value from the total point value; and
sending a request to the third party to send the reward to the peer.

21. A method in accordance with claim 20, further comprising:
verifying availability of the rewards in the list of rewards with the third party, and
preventing the peer from selecting a reward that is not available.

22. A method in accordance with claim 17, further comprising:
allowing the peer to pre-select at least one reward from a list of available rewards, each available reward having a reward point value;
intermittently verifying if the peer has accumulated a minimum total point value to be eligible for receiving the preselected reward; and
upon determining that the peer is eligible for receiving the pre-selected reward:
subtracting the reward point value from the total point value; and
sending the pre-selected reward to the peer.

23. A method in accordance with claim 17, wherein the attribute is selected among the number of bytes incoming to the peer, the number of bytes outgoing from the peer, the number of files successfully uploaded from the peer, the distributed processing made available by the peer, the distributed storage space made available by the peer, and the uptime during which the peer is connected to the network.

24. A method in accordance with claim 17, further comprising encrypting the collected statistics before transmitting them to the rewards server.

25. A system for dispensing rewards to a peer in a peer-to-peer network, based on contribution of the peer to the network, such system comprising:
means for monitoring at least one attribute indicative of the contribution of the peer to the network;
means for determining a point value in correlation with the monitored attribute; and
means for allowing the peer to be rewarded based on the number of points earned.

26. A system in accordance with claim 25, wherein the attribute is selected among the number of bytes incoming to the peer, the number of bytes outgoing from the peer, the number of files successfully uploaded from the peer, the distributed processing made available by the peer, the distributed storage space made available by the peer, and the uptime during which the peer is connected to the network.

27. A system in accordance with claim 25, wherein the means for monitoring at least one attribute comprise means for recording data at a peer level and means for transmitting the data to a rewards server.

28. A system in accordance with claim 27, wherein the means for determining a point value are located at the rewards server level.

29. A system in accordance with claim 28, further comprising means for encrypting the data before transmitting them to the rewards server.

30. A system in accordance with claim 25, wherein the means for determining a point value are located at the peer level.

31. A system in accordance with claim 30, further comprising means for encrypting the point value before transmitting it to a rewards server.

32. A system for dispensing rewards to a peer in a peer-to-peer network, based on contribution of the peer to the network, such method comprising:
means for collecting statistics concerning at least one attribute indicative of the contribution of the peer to the network;
means for transmitting the collected statistics to a rewards server;
means for processing the collected statistics to determine a new point value;
means for adding the new point value to a total point value of the peer;
means for monitoring the total point value;
means for sending a reward to the peer once the total point value has reached a minimum value, such reward having a rewards point value; and
means for subtracting the rewards point value from the total point value.

33. A system in accordance with claim 32, wherein the attribute is selected among the number of bytes incoming to the peer, the number of bytes outgoing from the peer, the number of files successfully uploaded from the peer, the distributed processing made available by the peer, the distributed storage space made available by the peer, and the uptime during which the peer is connected to the network.

34. A system in accordance with claim 32, further comprising means for encrypting the collected statistics before transmitting them to the rewards server.

35. A method of financing activities of a peer-to-peer client software provider through an incentive program rewarding peers for their contribution to resources to a peer-to-peer network, such method comprising:
registering peers in the incentive program;
receiving registration fees from the peers participating in the incentive program;
monitoring at least one attribute indicative of the contribution of each registered peer to the network;
determining a point value in correlation with the monitored attribute; and
allowing the registered peers to be rewarded based on their respective number of points earned in the incentive program.

36. A method in accordance with claim 35, wherein costs associated with the incentive program are exceeded by revenues generated through registration fees.

37. A method in accordance with claim 36, wherein the attribute is selected among the number of bytes incoming to the peer, the number of bytes outgoing from the peer, the number of files successfully uploaded from the peer, the distributed processing made available by the peer, the distributed storage space made available by the peer, and the uptime during which the peer is connected to the network.

38. A system for financing activities of a peer-to-peer client software provider through an incentive program rewarding peers for their contribution of resources to a peer-to-peer network, such system comprising:
means for registering peers in the incentive program;
means for receiving registration fees from the peers participating in the incentive program;
means for monitoring at least one attribute indicative of the contribution of each registered peer to the network;
means for determining a point value in correlation with the monitored attribute; and
means for allowing the registered peers to be rewarded based on their respective number of points earned in the incentive program.

39. A system in accordance with claim 38, wherein the attribute is selected among the number of bytes incoming to the peer, the number of bytes outgoing from the peer, the number of files successfully uploaded from the peer, the distributed processing made available by the peer, the distributed storage space made available by the peer, and the uptime during which the peer is connected to the network.
